(19) United States
(12) Patent Application Publication
(10) Pub. No.: US 2005/0061131 A1
(43) Pub. Date: Mar. 24, 2005

(54) Perforator for imaging apparatus, and paper handler provided therewith

(76) Inventors: Masahiro Tamura, Tokyo (JP); Nobuyoshi Suzuki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/901,049

(22) Filed: Jul. 29, 2004

(30) Foreign Application Priority Data
Aug. 1, 2003 (JP) 2003-285274 (JP)
May 25, 2004 (JP) 2004-154894 (JP)

(51) Int. Cl. B26D 5/00; B26D 7/06

(52) U.S. Cl. 83/681; 83/684

(57) ABSTRACT

A perforator wherein chad is prevented from falling or scattering into the apparatus and is reliably stored in the operating side of the main body front surface, erroneous detection or malfunctioning is prevented, a favorable appearance, small size, and superior operability are ensured, and high quality imaging and finishing are performed; and a finisher and an imaging apparatus equipped with the perforator. The perforator has a perforating device for perforating a transferred medium delivered by a delivery device, a chad recovery/delivery device for delivering the chad to the operating side of the main body front surface, a detachable chad storage device for storing the chad that separates from a curved part of the chad recovery/delivery device, a chad guide for guiding and delivering the chad to the chad storage device, and a chad delivery channel shielding member for shielding the guiding delivery channel for the chad of the chad guide when the chad storage device is opened to be attached or removed.

### BACKGROUND OF THE INVENTION

1. Field of the Invention

The present invention relates to a perforator for perforating a sheet-shaped recording medium, for example, paper; a paper handler that includes the perforator; and an imaging apparatus comprising the perforator or the paper handler, such as copy machine, fax machine, printer, or a combination of these. The present invention particularly relates to a perforator, paper handler, and imaging apparatus having a recovery mechanism for the chad after perforating.

2. Description of the Background Art

Paper finishers as paper handlers, and imaging apparatuses provided integrally or separately with these paper finishers include those that are provided with a perforator for perforating a sheet-shaped recording medium (hereinafter referred to as paper). In an apparatus provided with such a perforator, the main body of the imaging apparatus forms an image and the discharged paper is perforated by the perforator, then the paper is either discharged in unaltered form into a catch tray (discharged loading part), or delivered to a paper finisher for assorting, filing, or stacking.

Such a perforator includes a punch and die for opening holes in the paper, a punch chad delivery device for delivering the punch chad created when the punch and die open holes in the paper, and a punch chad box (hopper) for collecting the punch chad delivered by the punch chad delivery device. An example of such a perforator is disclosed in Japanese Laid-Open Patent Application Nos. 2001-25995, 7-112861, and 6-155393, for example.

In the perforator disclosed in Japanese Laid-Open Patent Application No. 2001-25995, the punch chad delivery device employs a screw-type delivery device, and is configured such that the punch chad box is detachably provided to the outer side of the main body of the imaging apparatus. The punch chad delivery device stops being driven when the punch chad box is removed from the main body of the imaging apparatus, but the image forming operation of the imaging apparatus continues. This conventional perforator is thereby designed such that the punch chad is not dispersed as waste to the exterior of the device.

Also, in the perforator disclosed in Japanese Laid-Open Patent Application No. 7-112861, the device for storing the chad during the perforation process is configured such that a punch chad receptacle can be detached from the imaging apparatus exterior via an opening formed in a side panel on the main body of the imaging apparatus, and is also configured such that forming the punch chad receptacle with transparent plastic or another such material allows the punch chad receptacle interior to be visible from outside the apparatus. The punch chad receptacle is also disposed on the side of the main body of the imaging apparatus, so punch chad can be easily processed from the exterior.

Furthermore, in the perforator disclosed in Japanese Laid-Open Patent Application No. 6-155393, the punch mechanism is mounted on an opening and closing cover provided to the side of the copy machine main body, and a paper ejecting tank for storing punch chad created when punch holes are opened by the punch mechanism can be detached from the opening and closing cover.

However, with a conventional perforator described above, sometimes the chad after perforation falls into the interior of the device or is scattered to the device exterior. When the chad thus falls into the device interior or is scattered to the device exterior without being collected in a chad collecting box or the like, the chad may enter the portion in the device relating to imaging and hinder the imaging process, or may be scattered onto the floor on which the device is installed and have an adverse effect on the work area.

### SUMMARY OF THE INVENTION

The present invention was designed in view of the circumstances with such conventional technology, and an object thereof is to provide a perforator whereby chad can be reliably prevented from falling and scattering into the device, a paper handler that includes this perforator, and various imaging apparatuses equipped therewith.

In an aspect of the present invention, a perforator comprises perforating means for perforating a sheet-shaped recording medium, chad recovery/delivery means for delivering the chad perforated by the perforating means, chad storage means for storing the chad delivered by the chad recovery/delivery means; and shielding means for shielding discharge channels whereby chad is discharged from the chad recovery/delivery means to the chad storage means.

In another aspect of the present invention, a paper handler comprises a perforator for perforating a sheet-shaped recording medium, and processing means for performing a predetermined process on the recording medium. The perforator comprises perforating means for perforating the recording medium, chad recovery/delivery means for delivering the chad perforated by the perforating means, chad storage means for storing the chad delivered by the chad recovery/delivery means, and shielding means for shielding discharge channels whereby chad is discharged from the chad recovery/delivery means to the chad storage means.

In another aspect of the present invention, an imaging apparatus integrally or separately comprises imaging means for forming an image on a recording medium, and a perforator for perforating the recording medium. The perforator comprises perforating means for perforating the recording medium, chad recovery/delivery means for delivering the chad perforated by the perforating means, chad storage means for storing the chad delivered by the chad recovery/delivery means, and shielding means for shielding discharge channels whereby chad is discharged from the chad recovery/delivery means to the chad storage means.

In another aspect of the present invention, an imaging apparatus integrally or separately comprises imaging means for forming an image on a recording medium, and a paper handler composed of a perforator for perforating the recording medium and processing means for performing a predetermined process on the recording medium. The perforator comprises perforating means for perforating the recording medium, chad recovery/delivery means for delivering the chad perforated by the perforating means, chad storage means for storing the chad delivered by the chad recovery/delivery means, and shielding means for shielding discharge channels whereby chad is discharged from the chad recovery/delivery means to the chad storage means.

### BRIEF DESCRIPTION OF THE DRAWINGS

The above and other objects, features, and advantages of the present invention will become more apparent from the following detailed description taken with the accompanying drawings in which:

FIG. 1 is a diagram showing the schematic structure of a perforator relating to one embodiment of the present invention;

FIG. 2 is a diagram showing an enlarged view of the main section in FIG. 1;

FIG. 3 is a diagram showing a state in which the shielding member blocks off the opening in FIG. 2;

FIG. 4 is a schematic perspective view showing the state of the shielding member in FIG. 3;

FIG. 5 is a schematic perspective view showing the state of the shielding member in FIG. 2;

FIG. 6 is a schematic perspective view showing the mounted state of the chad storage hopper in FIG. 5;

FIG. 7 is another schematic perspective view of the perforator in FIG. 6;

FIG. 8 is an enlarged perspective view of the shielding member in the same embodiment;

FIG. 9 is a diagram showing the schematic structure of a perforator relating to another embodiment of the present invention in which a chad separation accelerator is used;

FIG. 10 is a diagram showing the schematic structure of a perforator relating to yet another embodiment of the present invention in which a curved part is provided in two stages;

FIG. 11 is an explanatory diagram of the perforating operation of a press punch perforator in the present invention;

FIG. 12 is a diagram showing the configuration of a perforating mechanism containing the drive mechanism of the press punch perforator in FIG. 11;

FIG. 13 is an explanatory diagram of a rotary-punch perforating operation in the present invention;

FIG. 14 is a diagram showing the configuration of a perforating mechanism containing the drive mechanism of the rotary punch perforator in FIG. 12;

FIG. 15 is a plan view showing the primary configuration of a paper finisher relating to one embodiment of the present invention, that includes the perforator of the present invention;

FIG. 16 is a plan view showing a state in which the cover is opened in FIG. 15;

FIG. 17 is a schematic structural view of a paper finisher relating to another embodiment of the present invention;

FIG. 18 is a side view showing the schematic structure of the paper finisher in FIG. 17;

FIG. 19 is a diagram showing an enlarged view of the main section of the perforator in the paper finisher in FIG. 17;

FIG. 20 is a diagram showing the schematic structure relating to an embodiment of an imaging apparatus equipped with the perforator of the present invention;

FIG. 21 is a perspective view showing the main section of a paper finisher relating to yet another embodiment of the present invention;

FIGS. 22A to 22C are operating explanatory diagrams showing the relationship between the opened/closed state of the cover, the chad storage hopper, and the shutter member in the paper handler in FIG. 21; and

FIG. 23 is an explanatory diagram for describing a conventional perforator.

### DESCRIPTION OF THE PREFERRED EMBODIMENTS

Before describing the present invention, a conventional perforator and the problems therewith to be solved will be described.

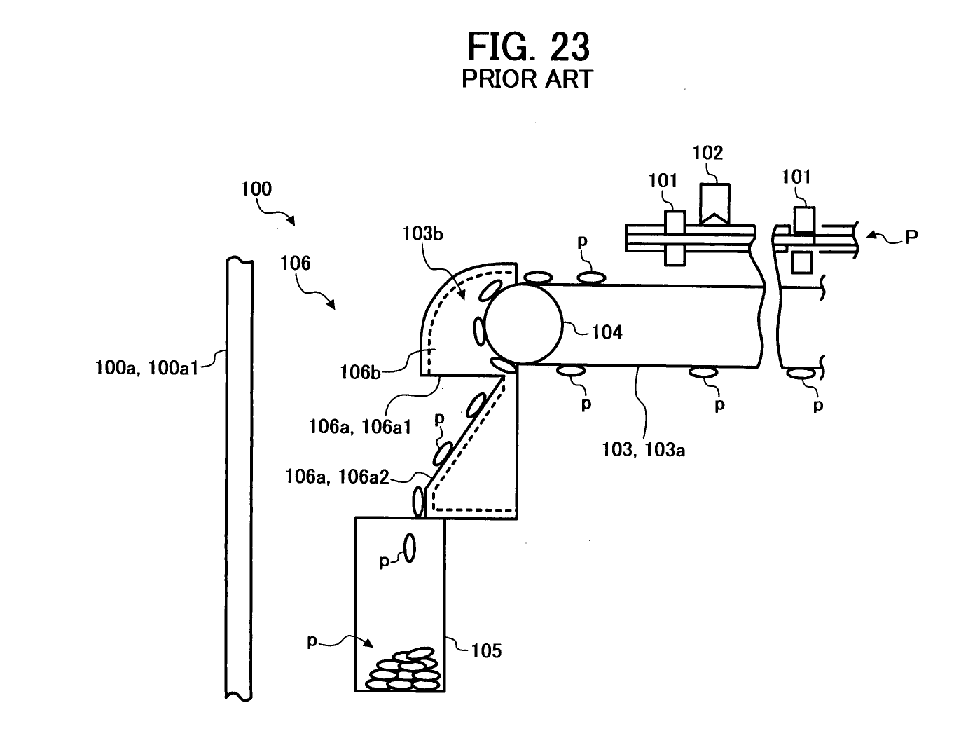

The configuration of a conventional perforator is shown in FIG. 23. In this perforator 100, chad p, which is formed when paper P fed by a feed roller 101 in a direction orthogonal to the paper surface is perforated with a punch and a die by a perforating device 102, is loaded onto a feed belt 103a wound around a timing pulley 104 of a chad delivery device 103, and is delivered to the operating side of a front opening/closing door 100a1 in the main body front surface 100a. Most of the chad p separates from the feed belt 103a at the winding part 103b of the timing pulley 104 of the feed belt 103a, dropped via a guiding delivery opening 106a1 and a guiding delivery slide 106a2 of a guiding delivery route 106a, which constitute a chad guiding delivery device 106, and stored in a chad storage box 105.

However, the chad p after perforation sometimes carries static electricity, and sometimes paper fuzz is generated. In the case of such static electricity or paper fuzz, the chad p adheres to the feed belt 103a and sometimes does not separate from the feed belt 103a when traveling down the winding part 103b. When the chad p adheres to the feed belt 103a and does not fall to be stored in the chad storage box 105, the chad p moves around in unaltered form to the reverse side (underside) of the feed belt 103a from the winding part 103b as illustrated. Upon moving to the reverse side of the feed belt 103a in this manner, the chad p sometimes falls into the device interior or is scattered to the device exterior.

Thus, when the chad p is not stored in the chad storage box 105 but moves around to the reverse side of the feed belt 103a to be dropped into the device interior or scattered to the device exterior, the chad p sometimes blocks a reflective sensor or the like, and when the sensor for performing the detection necessary to imaging is blocked, errors sometimes occur in the detection or operation of the sensor, and the quality of the formed image is reduced as a result. Also, when a perforator is provided inside the main body of an imaging apparatus, chad sometimes is scattered in the apparatus and enters the portions involved in imaging, which hinders the imaging process.

Furthermore, when the front opening/closing door 100a1 of the front surface 100a is opened, the chad p still adhering to the middle or circumference of an internal hole 106b in the guiding delivery opening 106a1, the chad p that has fallen into the device interior due to wind pressure or the like, or the chad p scattered inside the apparatus sometimes flies outside of the apparatus and is scattered to the floor on which the apparatus is installed, which has an adverse effect on the work area.

In any case, when the front opening/closing door 100a1 is opened, or when the front opening/closing door 100a1 is closed with the chad storage box 105 still removed, and the perforating operation is performed, the chad p cannot be prevented from falling or scattering into the device interior.

The embodiments of the present invention designed to solve the problems with conventional technology described above will now be described in detail with reference to the diagrams.

In the following embodiments, the perforating device corresponds to the symbol 2; chad to the symbol p; the chad recovery/delivery device to the symbol 3; the chad storage device to the symbol 5 or a chad storage hopper 5a; the shielding device to a shielding member 7; the opening and closing member to the shielding member 7 or a shutter member 7f; the fulcrum to a fulcrum 7e; the shielding part to the symbol 7a; the through-hole part to the symbol 7c; the slide surface to a slanted surface section 7c1; the elastic urging device to a torsion spring 7d; the operating device to the chad storage hopper 5a or an operating part 10b; the opening and closing door to the symbol 0a1 or a front cover 10a1; the detection device to the symbol 9 or a range sensor 9a; the guiding device to a chad guide 6; the separating device to a chad separation accelerator 8, a pressing member 8a, or a peeling member 8c; the paper finisher to the symbol 10; and the imaging apparatus to the symbol 50.

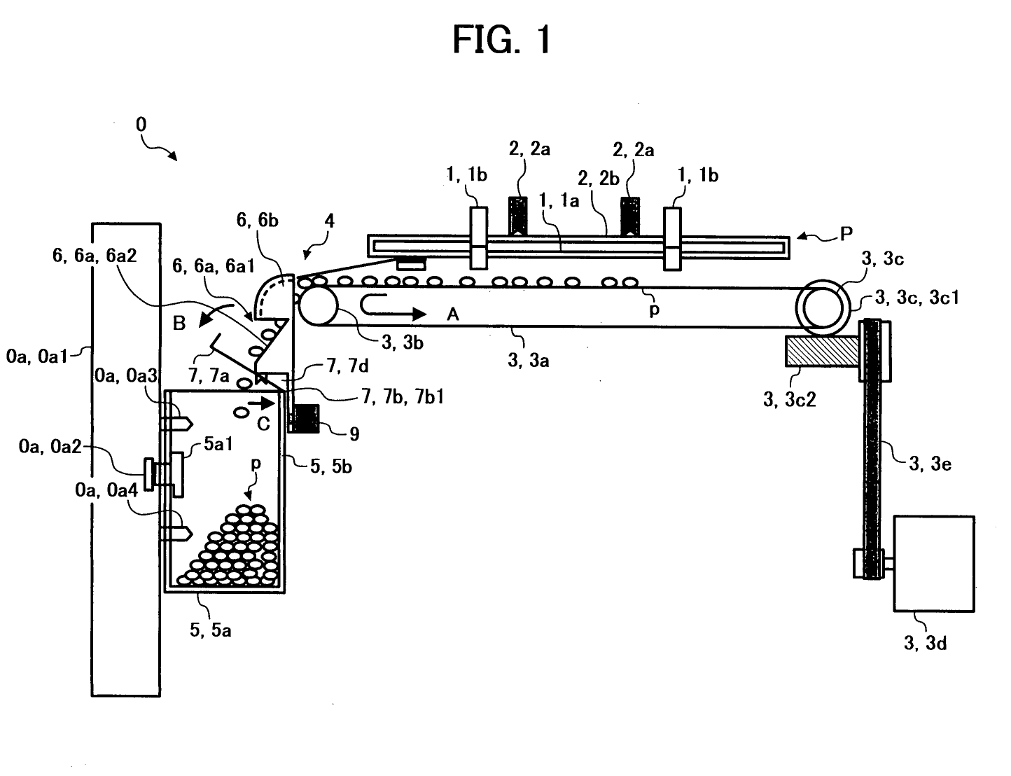

First, the configuration and operation of a perforator relating to an embodiment of the present invention will be described with reference to FIGS. 1 through 5.

In these diagrams, a perforator 0 for perforating paper (sheet-shaped transfer medium, hereinafter referred to as paper) and recovering the resulting chad is composed of a feed device 1 for feeding the paper P from a feed opening 1a with a pair of feed rollers 1b in a direction orthogonal to the surface of the paper in FIG. 1; a punch 2a and die 2b constituting a perforating device 2 for perforating the paper P fed from the feed opening 1a and the feed rollers 1b; a delivery belt as a delivery member 3a wound around a pulley 3b and a pulley 3c constituting a chad recovery/delivery device 3 for recovering the chad p formed from the perforation of the punch 2a and die 2b and delivering the chad p to the operating side of an opening and closing door 0a1 in the main body front surface 0a (hereinafter referred to as an opening and closing door); a curved part 4 (curving delivery part) provided to the operating side of the opening and closing door 0a1 for separating the chad p delivered by the delivery member 3a from the delivery member 3a; a chad storage hopper 5a as a chad storage device 5 designed to store the chad p separated from the curved part 4 and to be detachable from the opening and closing door 0a1; a chad guide 6 for guiding the chad p that separates and falls from the curved part 4 into the chad storage hopper 5a; and a shielding part 7a of the shielding member 7 that is rotatably supported in the direction of shielding a guiding delivery opening 6a1 of a guiding delivery channel 6a for the chad p of the chad guide 6 when opened to attach or detach the Chad storage hopper 5a, and that is designed for shielding the chad delivery channel.

According to this configuration, the chad p can be prevented from falling or scattering into the apparatus, it is possible to store the chad reliably on the operating side of the opening and closing door 0a1, and errors in detection and operation can be prevented. Furthermore, since the chad p is prevented from falling or scattering, the apparatus has a clean appearance, is compact, and has superior operability without inducing deterioration in the surrounding area. This is described in detail below.

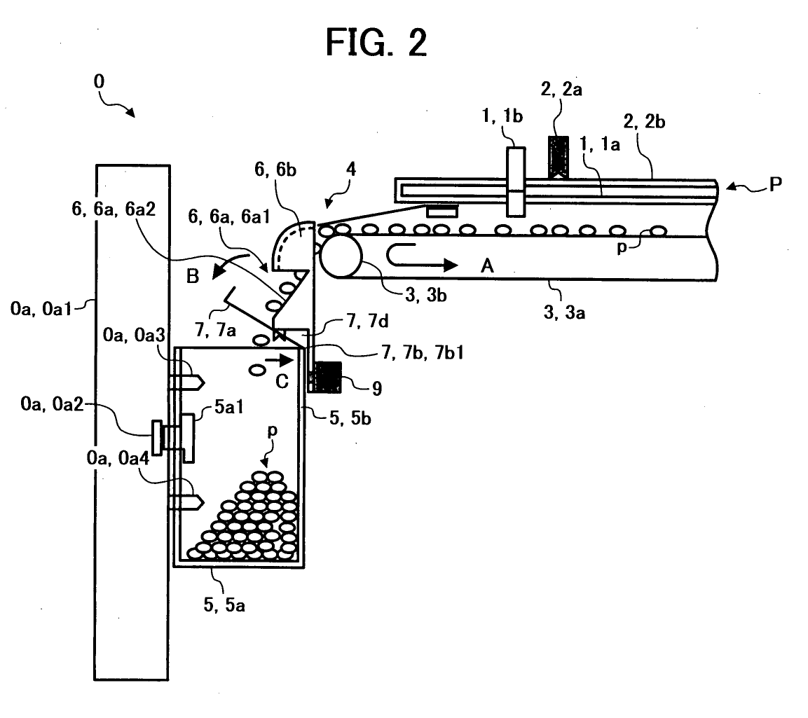

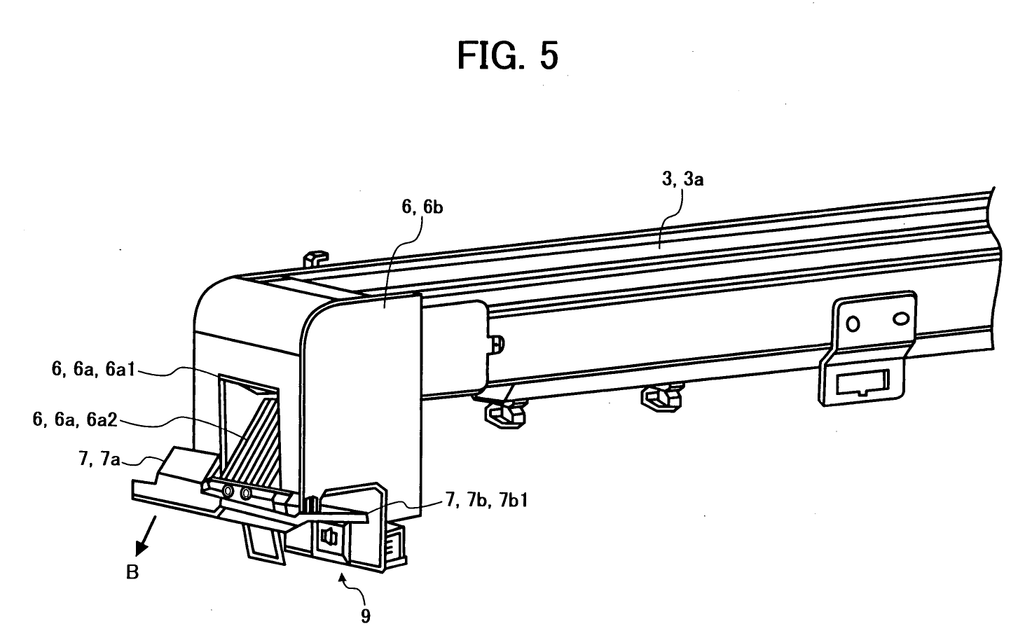

The chad p resulting from perforating the paper P with the punch 2a and die 2b falls on the delivery member 3a that rotates in the direction of the arrow A, then delivered to the operating side of the opening and closing door 0a1, and caused to pass through the guiding delivery opening 6a1 and the declining part 6a2 of the chad guide 6 to be stored in the chad storage hopper 5a as shown in FIGS. 1 and 2, whereupon the shielding part 7a rotates in the direction of the arrow B in FIGS. 1 and 2 to reach an opened state (see FIG. 5). A detachment detection part 7b of the chad storage device extends integrally with the shielding part 7a on the opposite side of an axle for pivotably supporting the shielding part 7a. The presence of the detachment detection part 7b is detected by a detection device 9 composed of a reflective photosensor.

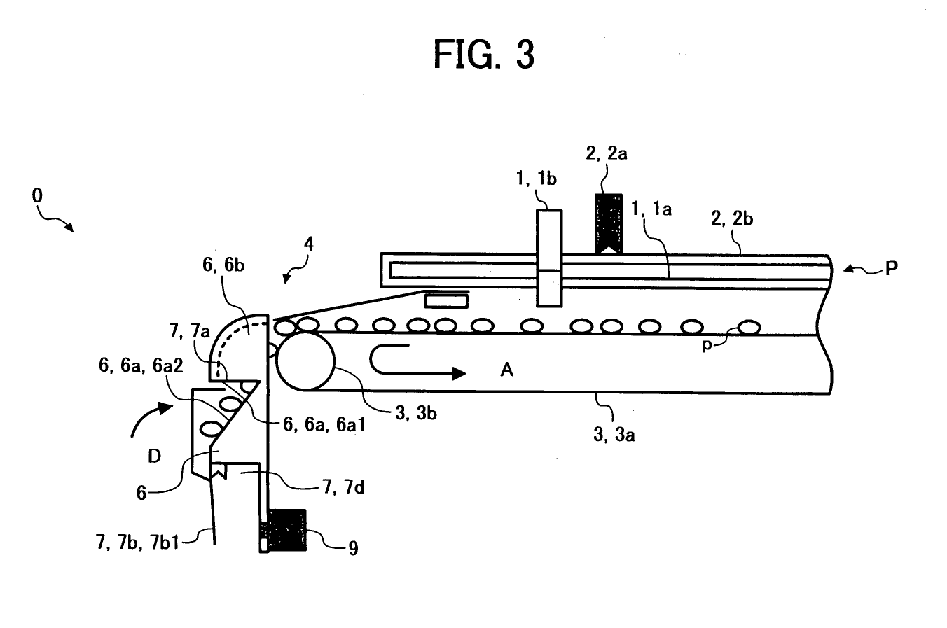

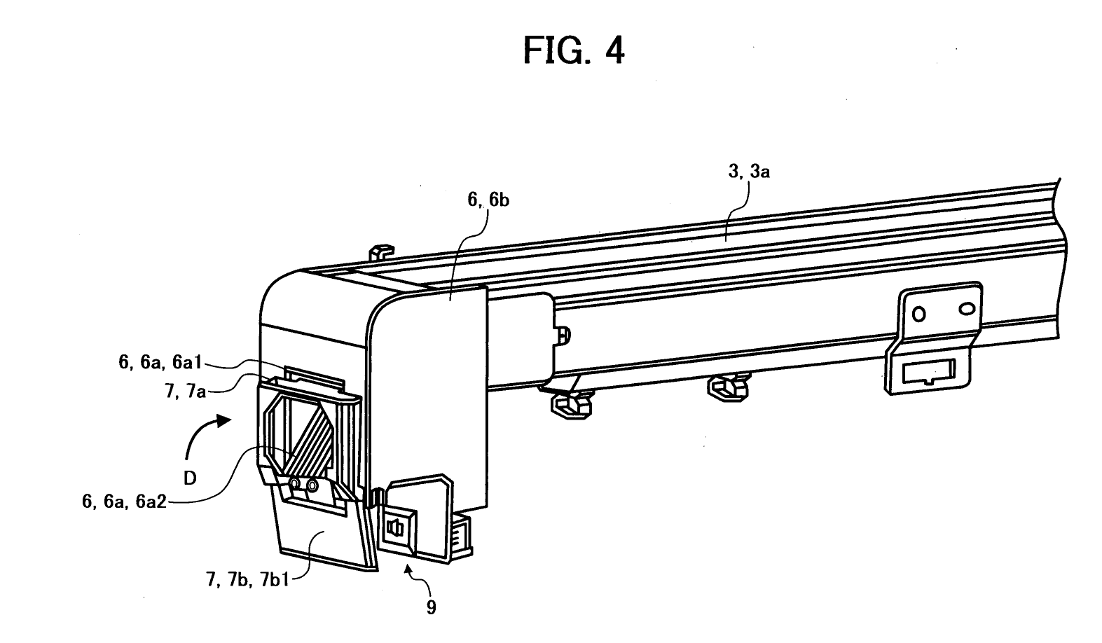

When the shielding part 7a is closed as in FIG. 4, the detecting sensor of the detection device 9 detects the detachment detection part 7b, and when the shielding part is open as in FIG. 5, the detachment detection part 7b is no longer detected because the detachment detection part 7b is out of the path of the detected light, and the amount of chad p stored in the chad storage hopper 5a can be detected through a hole 5b provided to the chad storage hopper 5a. The chad storage hopper 5a can thereby also be automatically detected to be full with chad p by the detection device 9. Specifically, the chad storage hopper 5a mounted on the inner side of the opening and closing door 0a1 reaches a state such as is shown in FIG. 2 due to pressing on the front surface 7b 1 of the detachment detection part 7b in the direction of the arrow C in FIGS. 1 and 2 when the opening and closing door 0a1 is closed, and the chad storage hopper 5a can be automatically detected to be full with chad p as a result. Also, when the opening and closing door 0a1 is opened, the chad storage hopper 5a mounted on the inner side of the opening and closing door 0a1 is separated from the front surface 7b 1 of the detachment detection part 7b, and the detachment detection part 7b reaches a state such as is shown in FIG. 3 due to the torsion spring 7d (see FIG. 4).

The torsion spring 7d applies elastic urging force such that the detachment detection part 7b reaches a state such as is shown in FIG. 3 (state in which the part is located at the front of the detection device 9) (see FIG. 4). When the detachment detection part 7b reaches a state such as is shown in FIG. 3, the detection sensor of the detection device 9 can detect the detachment detection part 7b and recognize that the chad storage hopper 5a has been removed. At this time, the shielding part 7a provided to the opposite side around the rotational axis rotates in the direction of the arrow D in FIG. 3 and automatically blocks the opening 6a1 of the guiding delivery channel 6a, so it is possible to prevent the chad p remaining in the center of the hole 6b in the chad guide 6 from overflowing.

Thus, since the shielding part 7a is subjected to the action of elastic urging force in the direction in which the opening 6a1 is always shielded, the chad p can be reliably prevented from falling or scattering into the apparatus, and the chad p can also be reliably stored in the chad storage hopper 5a on the operating side of the opening and closing door 0a1. As a result, it is possible to provide a compact perforator 0 with a favorable appearance and superior operability, wherein erroneous detection and operation in the sensors is prevented.

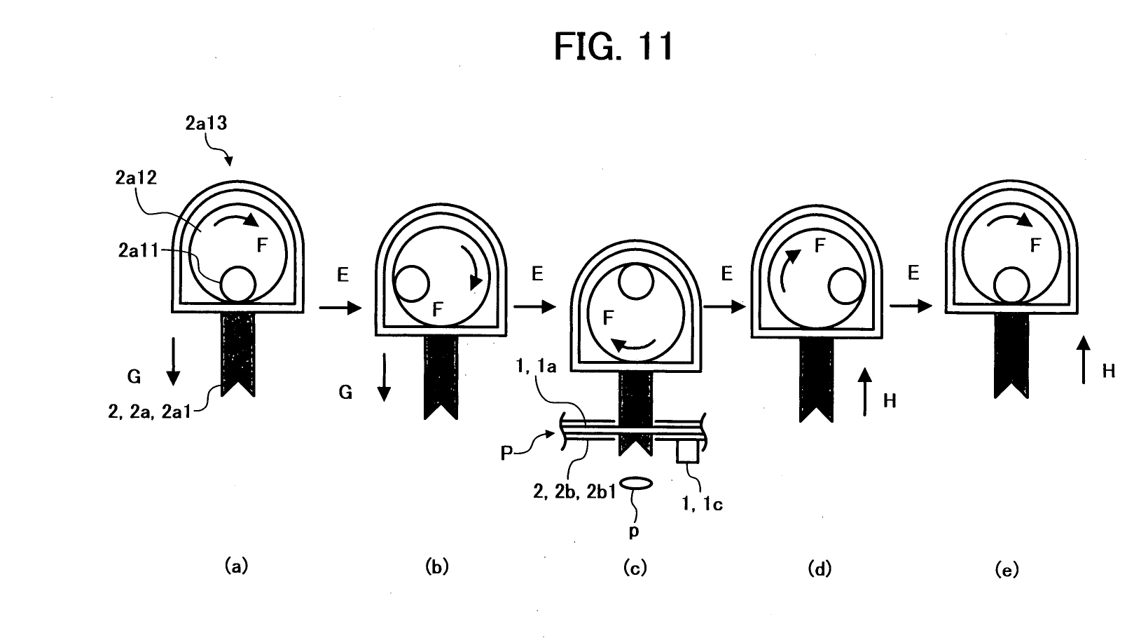

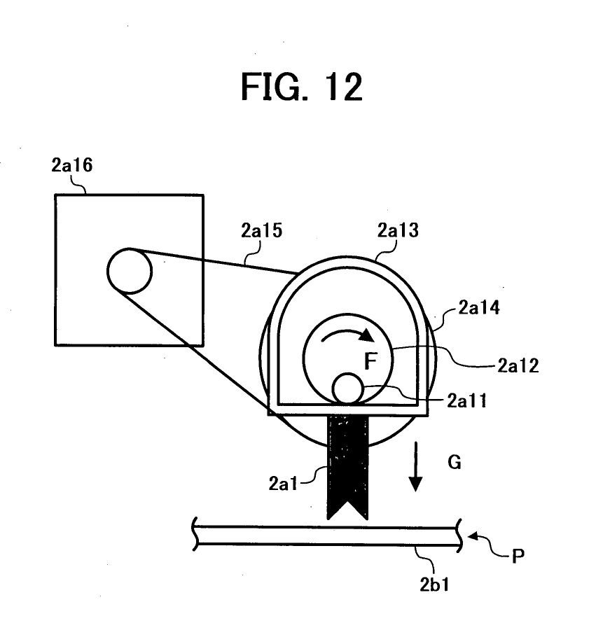

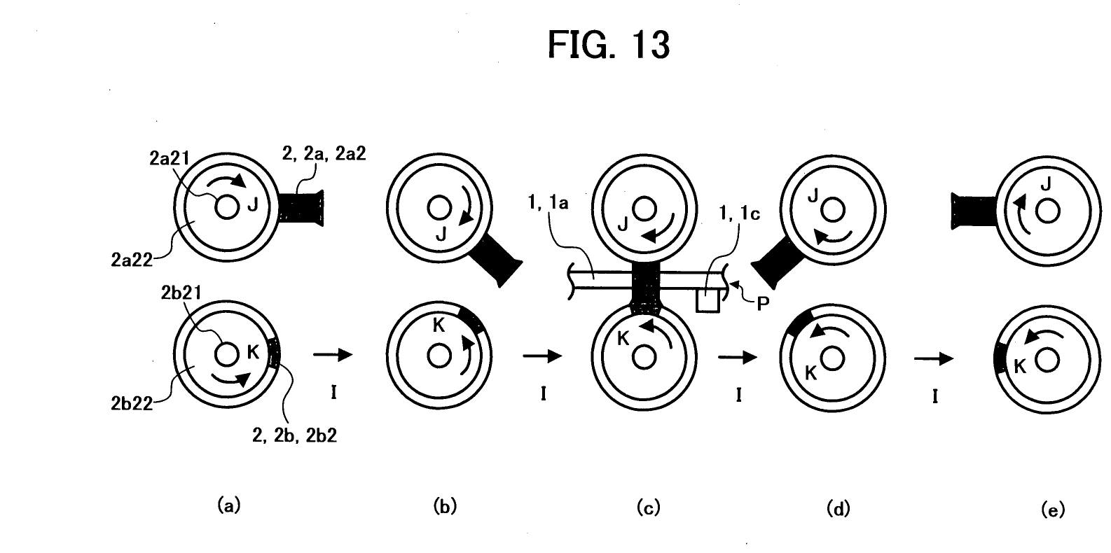

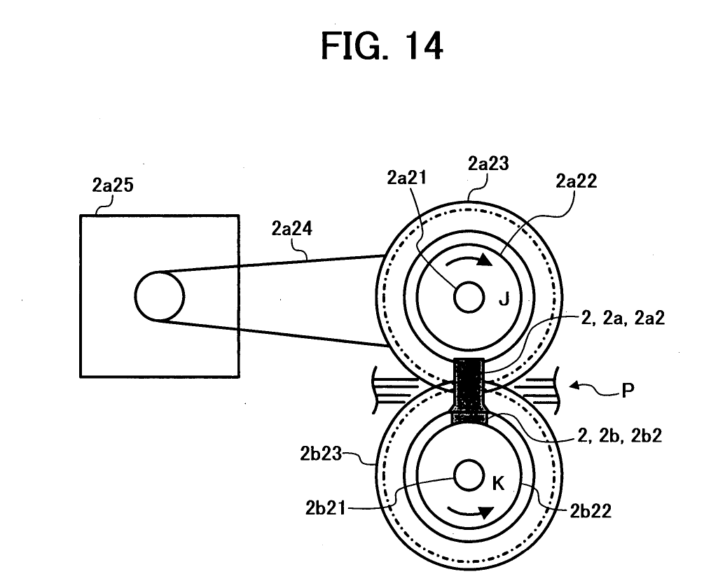

A press punch-type (see FIGS. 11 and 12) or rotary punch-type (see FIGS. 13 and 14) perforator can be installed as the perforating device 2 in the perforator 0. When either type of perforator 0 is used, the chad p resulting from perforating the paper P fed from the feed opening 1a and feed rollers 1b with the punch 2a and die 2b falls onto the delivery member 3a (delivery belt) of the chad recovery/delivery device 3. As shown in FIG. 1, the delivery member 3a is stretched to undergo tension by the timing pulley of the pulley 3b and the timing pulley of the pulley 3c, and the delivery member 3a on the falling side of the chad p moves in the direction of the arrow A in FIGS. 1 and 2, whereby the chad p is delivered to the operating side of the opening and closing door 0a1 and is separated at the curved part 4 by the hole 6b in the chad guide 6.

The delivery member 3a is driven as a result of the fact that a worm wheel 3c1 integrated with the timing pulley of the pulley 3c is meshed with a worm 3c2 and that the worm 3c2 is rotated. The worm 3c2 is rotatably driven by a stepping motor 3d via a timing belt 3e.

The chad p delivered to the operating side of the opening and closing door 0a1 by the delivery member 3a and separated from the curved part 4 passes through the guiding delivery opening 6a1 of the delivery channel 6a and a sloping guide of the guiding delivery slide unit 6a2, and falls into the detachable chad storage hopper 5a, where it is stored. The chad storage hopper 5a is mounted in a detachable configuration on the inner side of the openable and closable opening and closing door 0a1, or on the inner side of a paper finisher 10 (not shown). Therefore, the chad p falls into the apparatus and is reliably stored in the chad storage hopper 5a on the operating side of the opening and closing door 0a1 without scattering.

A magnet 5a1 is mounted on the chad storage hopper 5a, and is held by magnetism to a bracket 0a2 affixed to the inner side of the opening and closing door 0a1. Pins 0a3 and 0a4 are provided to part of the opening and closing door 0a1 as guides during magnetization, a guide function is provided by inserting the pins through a hole provided to the side wall of the chad storage hopper 5a, and the chad storage hopper 5a is capable of being attached or detached due to the presence or absence of magnetism in the magnet 5a1 and the bracket 0a2.

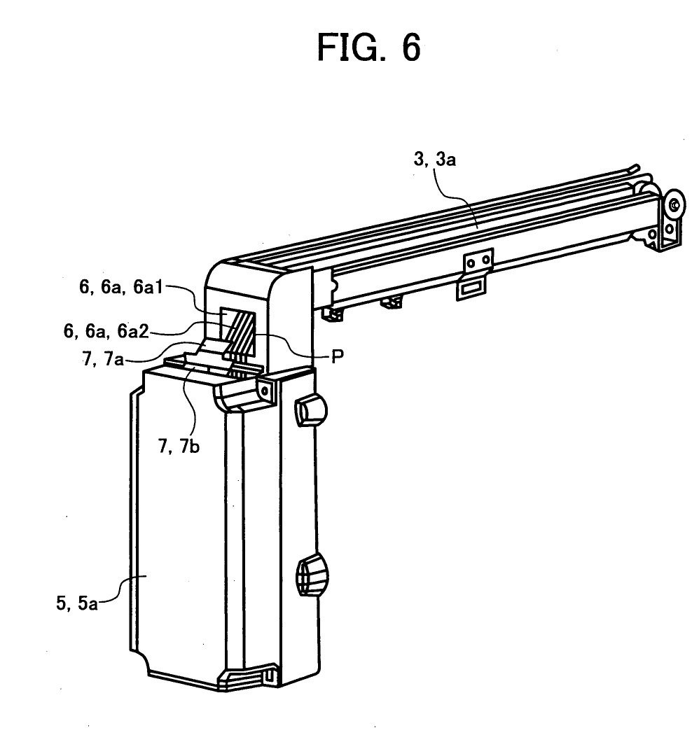

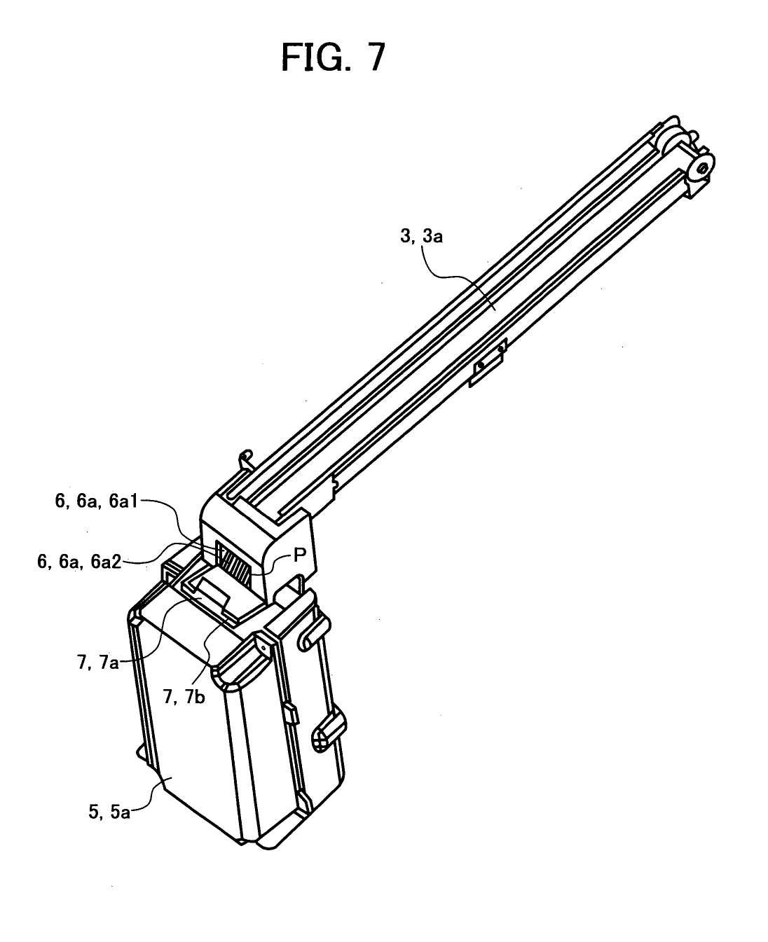

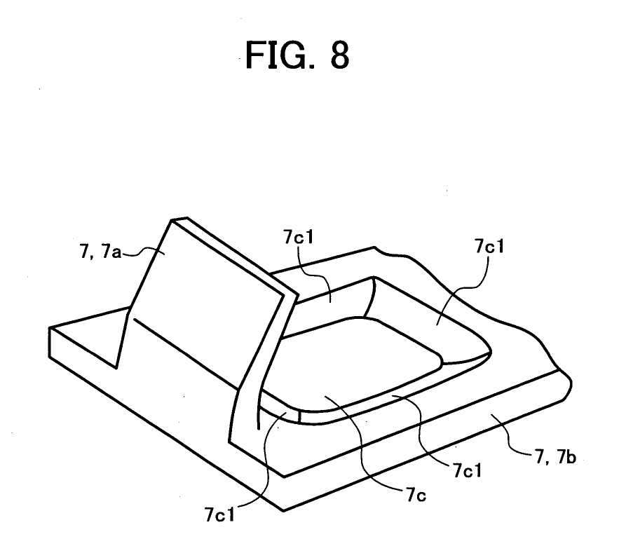

The configuration of a perforator relating to another embodiment of the present invention is shown in FIGS. 6 through 8. In these diagrams, a chad through-hole 7c is provided to prevent circumstances in which the chad p passing through the opening 6a1 of the guiding delivery channel 6a and the sloping guide of the guiding delivery slide unit 6a2 to be stored in the chad storage hopper 5a could be caught on the detachment detection part 7b and not fall, and the surrounding frame of the chad through-hole 7c is provided with a slanted surface part 7c 1 whose surface is slanted such that the opening narrows down in the direction in which the chad p is delivered (the falling direction) (see FIG. 8). Such a hole configuration allows the chad p to slide off the slide surface of the slanted surface part 7c 1 and be reliably stored in the chad storage hopper 5a, even if the chad p falls into the chad through-hole 7c or the frame surrounding the chad through-hole 7c.

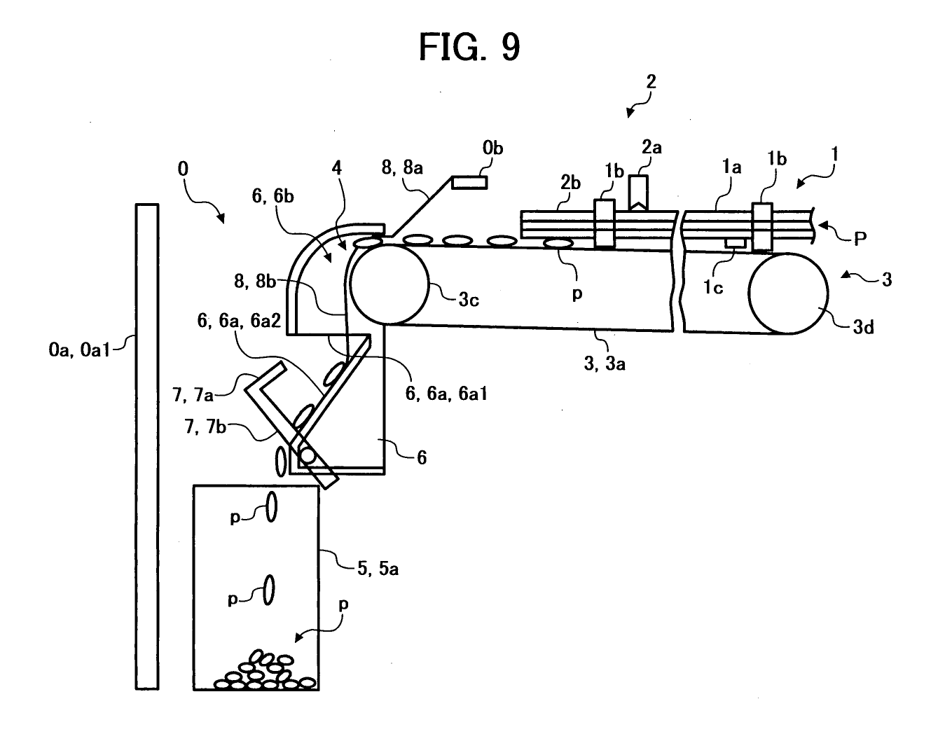

The configuration of a perforator relating to another embodiment of the present invention, wherein a chad separation accelerator 8 is provided to the chad guide 6, is shown in FIG. 9. In this diagram, the chad separation accelerator 8 accelerates the separation of the chad p delivered by the delivery member 3a, and a pressing member 8a constituting the chad separation accelerator 8 presses on the back tips of the chad p on the delivery member 3a upstream of the curved part 4 to cause the front tips of the chad p to rise from the top of the delivery member 3a, whereby the chad p easily separates from the delivery member 3a at the curved part 4. Thus, the chad p on the delivery member 3a is caused to separate from the delivery member 3a and is reliably stored in the chad storage hopper 5a of the chad storage device 5. The pressing member 8a is made from a resin material in film form, is therefore easily machined and attached, and is fixed and held by a main body frame 0b or another such fixing member.

A peeling member 8b constituting the chad separation accelerator 8 is disposed on the curved part 4 immediately after the part where the pressing member 8a is set in the delivery path of the chad p. This peeling member 8b further accelerates peeling due to the pressing member 8a, and has the function of bringing the tip of the peeling member 8b in contact with the bottom of the tips of the chad p whose tips are raised by the pressing member 8a, and peeling the chad p from the top of the delivery member 3a to reliably separate the chad p from the delivery member 3a.

Thus, the chad p on the delivery member 3a can be reliably separated from the delivery member 3a as a result of the tip of the peeling member 8b coming into contact with and pushing up the raised portions of the chad p whose tips have been raised from the delivery member 3a by the pressing member 8a. The peeling member 8b is composed of a resin material in film form and is therefore easily machined and attached, and the member is fixed and held on the chad guide 6. The chad separation accelerator can thereby be configured at low cost.

Consequently, the chad p formed by perforating the fed paper P with the punch 2a and die 2b can be reliably separated from the delivery member 3a for delivery to the operating side of the opening and closing door 0a1, and can be reliably stored in the chad storage hopper 5a.

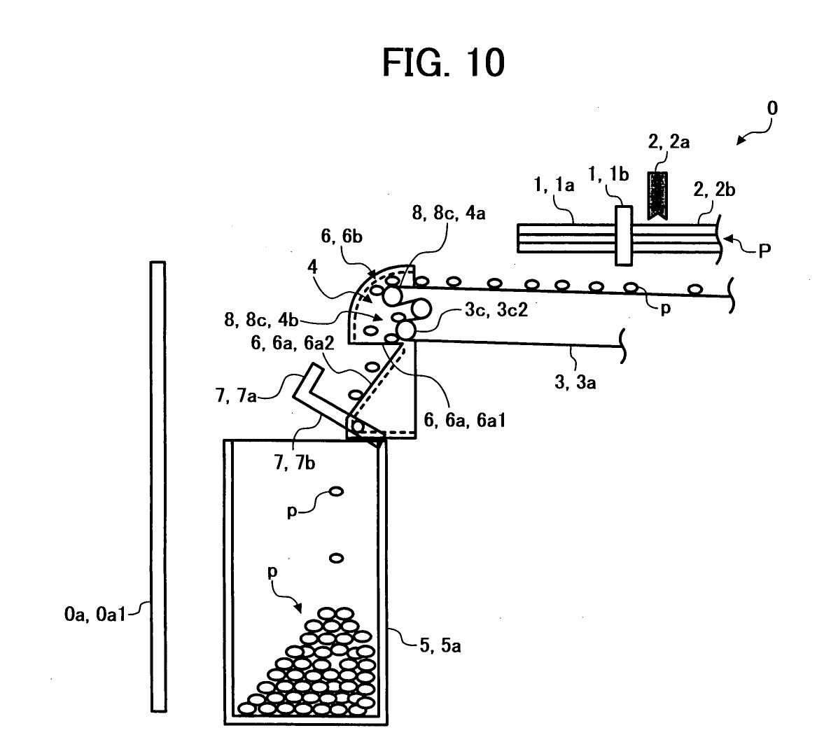

The configuration of a perforator relating to yet another embodiment of the present invention that includes another chad separation accelerator 8 is shown in FIG. 10. Specifically, in this embodiment, the chad separation accelerator 8 for accelerating the separation of the chad p delivered by the delivery member 3a is configured from a plurality of curved parts 8c (curving delivery parts). These curved parts 8c are composed of high positioned curved parts 4a and low positioned curved parts 4b disposed at a lower position than the high positioned curved parts 4a. A plurality of these curved parts 4a and 4b is set at positions of different height, whereby the chad p formed by perforating the fed paper P with the punch 2a and die 2b can be reliably separated from the delivery member 3a for delivery to the operating side of the opening and closing door 0a1 of the main body front surface 0a. In this embodiment, among the plurality of curved parts 8c, the high positioned curved parts 4a protrude farther out to the side of the opening and closing door 0a1 than the low positioned curved parts 4b. This allows the chad p separated from the delivery member 3a at the first high positioned curved part 4a to come into contact with, but not adhere to, the next low positioned curved part 4b, whereby the chad p falls into the guiding delivery slide unit 6a2 of the guiding delivery channel 6a in the chad guide 6, and can be reliably stored in the chad storage hopper 5a. Also, the purpose of disposing the high positioned curved parts 4a and the low positioned curved parts 4b at different heights is to ensure that the chad guide 6 does not increase in size.

Next, a press punch-type perforating operation will be described with reference to FIG. 11. The symbols (a) through (e) in FIG. 11 indicate an operating simulation for the perforating blade 2a1 of the punch 2a in the perforating device 2 in the direction of the arrows E in the diagram. The perforating blade 2a1 is moved up and down in relation to the paper P in the direction of the arrow G in the diagram or in a direction perpendicular to the direction of the arrow H in the diagram by a cam 2a12 that rotates around an axle 2a11 in the direction of the arrow F in the diagram, and the paper P is perforated in the state indicated by (c) in FIG. 11. The perforated location is set after a specific time passes since the back edge of the paper P has passed through an inlet sensor 1c disposed in the feed opening 1a, or after a set pulse has passed, and the paper is perforated by the press-punch perforating blade 2a1 when the paper has stopped after the specific time or the set pulse has passed.

The configuration of a press-punch perforating device 2 having a drive mechanism is shown in FIG. 12. In this diagram, the press-punch perforating blade 2a1 presses the inner wall of a holder 2a13 in contact with the outer cam surface of the cam 2a12 down towards the paper P in the direction of the arrow G in the diagram when the cam 2a12 meshed with the axle 2a11 rotates around the axle 2a11 in the direction of the arrow f in the diagram. The pressed down holder 2a13 performs perforation by pressing the press-punch perforating blade 2a1 meshed with the holder 2a13 down towards the paper P in the direction of the arrow G in the diagram.

A pulley 2a14 is mounted on the axle 2a11, and this pulley is rotated by a drive from a stepping motor 2a16 via a timing belt 2a5. The drive from the pulley 2a14 to the axle 2a11 causes the pulley 2a14 to be constantly rotated by the stepping motor 2a16 via the timing belt 2a15, and this drive is transmitted to the axle 2a11 by a single rotation clutch when needed. Alternatively, a configuration is possible wherein the stepping motor 2a16 instead of a single rotation clutch is repeatedly stopped and driven to transmit the drive to the axle 2a11.

Next, a rotary-punch perforating operation will be described with reference to FIG. 13. The symbols (a) through (e) in FIG. 13 indicate an operating simulation for the perforating blade 2a2 of the punch 2a in the perforating device 2 in the direction of the arrows I in the diagram. The rotary-punch perforating blade 2a2 rotates around an axle 2a21 in the direction of the arrow J in the diagram, and a rotary punch-type die 2b2 for the die 2b is provided at a position lined up with the perforating blade 2a2. The die 2b2 rotates around an axle 2b21 in the direction of the arrow K in the diagram. The perforating blade 2a2 and the die 2b2 begin to rotate after the back edge of the paper P passes through the inlet sensor 1c disposed in the feed opening 1a and after a specific pulse has passed, and the paper P is perforated in the state shown in (c) of FIG. 13.

The configuration of a drive system for a rotary punch perforator is shown in FIG. 14. The perforating blade 2a2 and the die 2b2 are mounted respectively on a pair of rotating members 2a22 and 2b22 sandwiching the paper P therebetween, as shown in the diagram. The rotating members 2a22 and 2b22 rotate around an axle 2a21 and an axle 2b21 in the direction of the arrows J and K in the diagram, respectively. A gear 2a23 and a gear 2b23 are mounted respectively on the axle 2a21 and the axle 2b21 of the perforating blade 2a2 and die 2b2, and rotational force is transmitted by the meshing of the gear 2a23 and the gear 2b23. The drive is transmitted to the gear 2a23 from a stepping motor 2a25 via a timing belt 2a24.

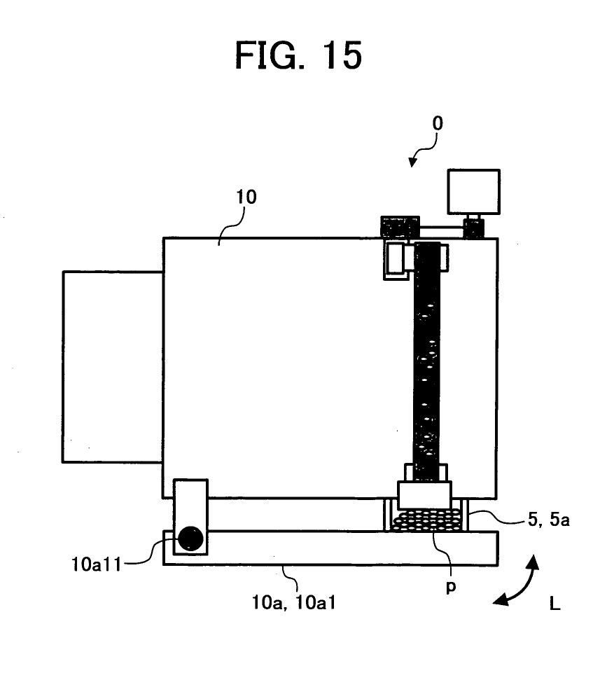

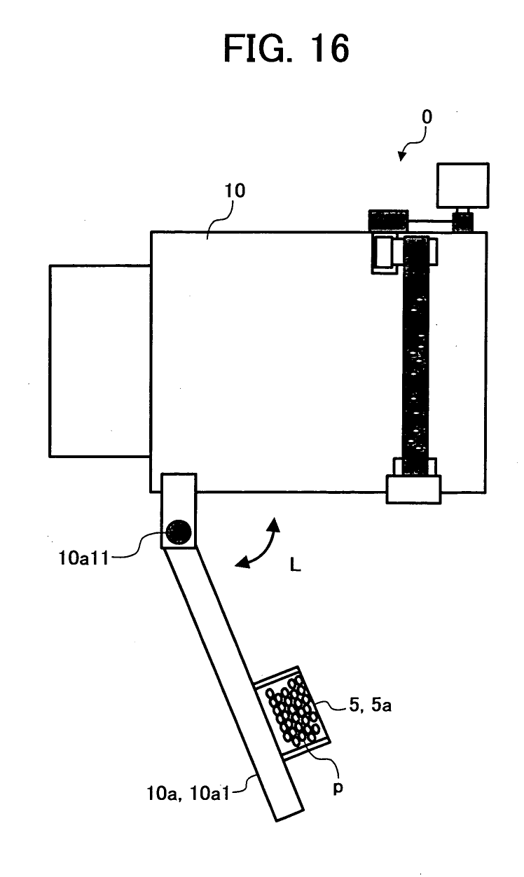

The configuration of an embodiment relating to the paper finisher 10 that includes the perforator 0 of the present invention is shown in FIGS. 15 and 16. As can be seen from these diagrams, the front cover 10a1 capable of opening and closing in the direction of the arrow L in the diagram is provided in place of the opening and closing door 0a1 to the operating side of the main body front surface 10a of the paper finisher 10. The chad storage hopper 5a is mounted on the front cover 10a1. FIG. 15 shows the front cover 10a1 closed, and FIG. 16 shows the front cover 10a1 opened.

In this embodiment, when the front cover 10a1 turns around a fulcrum 10a11 to open (see FIG. 16), the chad storage hopper 5a also turns accordingly. In the chad storage hopper 5a, the delivery channel of a delivery device 11 (not shown) is blocked off when the front cover 10a1 is turned and closed (see FIG. 15), and even if an attempt is made to open or close the delivery channel of the delivery device 11 to remove a paper jam or the like, the chad storage hopper 5a remains fixed in its position and is not released, which makes it difficult to remove the paper jam. Specifically, when the front cover 10a1 is opened during to remove a paper jam or the like, the chad storage hopper 5a of the chad storage device 5 must also move integrally with the front cover 10a1. In view of this, the paper finisher 10 relating to this embodiment is configured such that the chad storage hopper 5a also turns integrally when the front cover 10a1 is opened. The front cover 10a1 is thereby integrally opened to remove a paper jam, so operability is not affected. Also, there is no need for a configuration in which the chad storage hopper 5a can be mounted between the mechanisms in the paper finisher 10, and the hopper is provided to the inner side of the front cover 10a1. Therefore, the chad storage hopper 5a can be enlarged and the capacity for storing chad p can be increased within a small space.

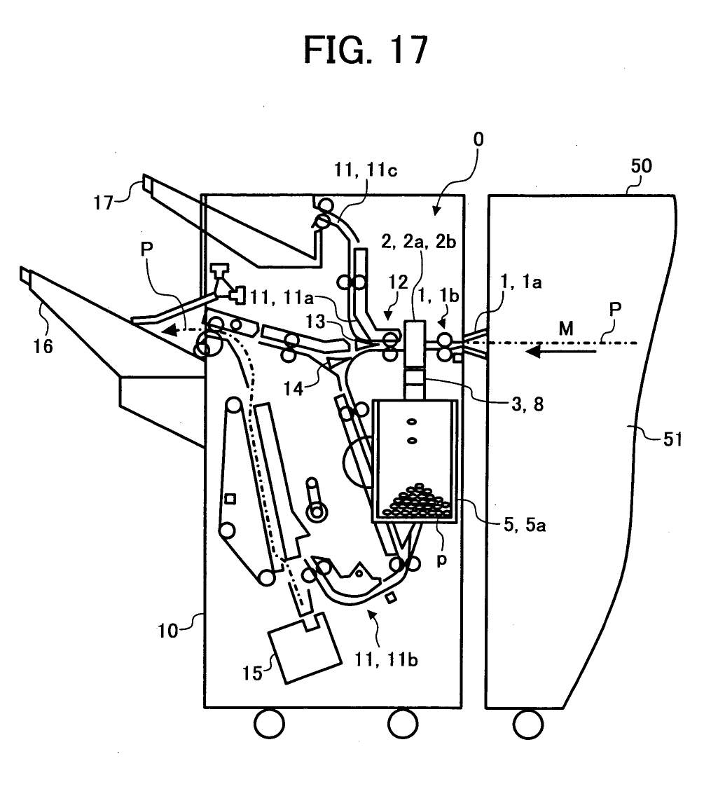

The internal configuration of a paper finisher 10 relating to another embodiment that includes the perforator 0 of the present invention is shown in FIGS. 17 through 19. In these diagrams, an image is formed in the paper finisher 10 by the imaging device 51 of an imaging apparatus 50, and the discharged paper P is fed from the direction of the arrow M in the diagram (see FIG. 17). The paper P fed to the paper finisher 10 is delivered from the feed opening 1a of the perforator 0 by the feed rollers 1b, and is then delivered to a pair of delivery rollers 12 in the feed/delivery channel 11a of the delivery device 11 after passing through the feed rollers 1b. The punch 2a and die 2b of the perforator 0 for perforating the fed paper P are disposed between the feed rollers 1b and the delivery rollers 12. Also, a chad recovery/delivery device 3 for recovering the chad p after perforation has been performed by the punch 2a and die 2b is mounted together with the chad separation accelerator 8 (refer to the embodiments) as illustrated beneath the punch 2a and die 2b of the perforator 0.

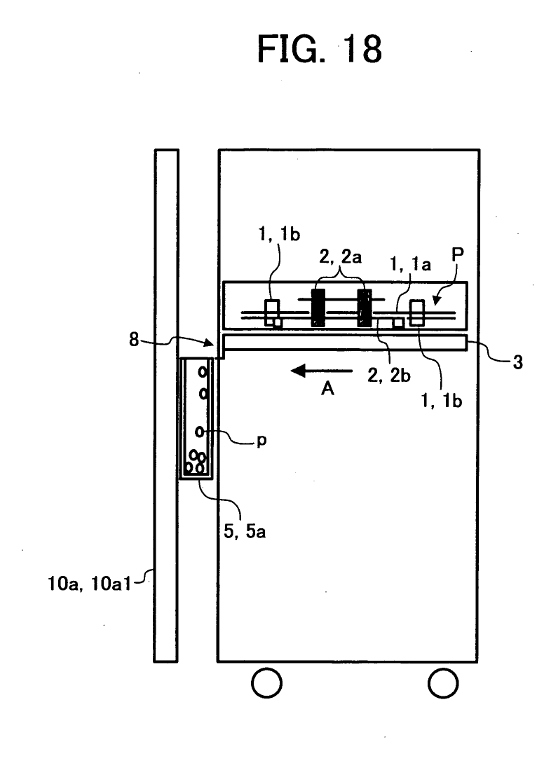

After being perforated by the punch 2a and die 2b, the chad p is delivered in the chad delivery direction (the direction of the arrow A in FIG. 18) by the chad recovery/delivery device 3. This chad delivery direction is on the operating side of the front cover 10a1 by which the user operates the apparatus or deals with paper jams, and the chad p is stored by being loaded inside the chad storage hopper 5a disposed on the operating side of the front cover 10a1. The paper P perforated by the punch 2a and die 2b is delivered to the delivery channels due to the switching operation of a forked nail 13 and a forked nail 14 disposed downstream of the delivery rollers 12, and is loaded onto an discharged paper tray 16 after passing through a finishing delivery channel 11b of a delivery device 11 for performing a subsequent finishing step such as stapling in a stapler 15 or the like. Otherwise, if simple discharge is involved, the paper P is loaded on a proof tray 17 after passing through a simple discharge/delivery channel 11c. Specifically, since the punch 2a, the die 2b, and the chad storage hopper 5a are disposed the farthest upstream of the finishing steps, the paper P delivered essentially to any delivery channel 11a, 11b, or 11c can be perforated as a result.

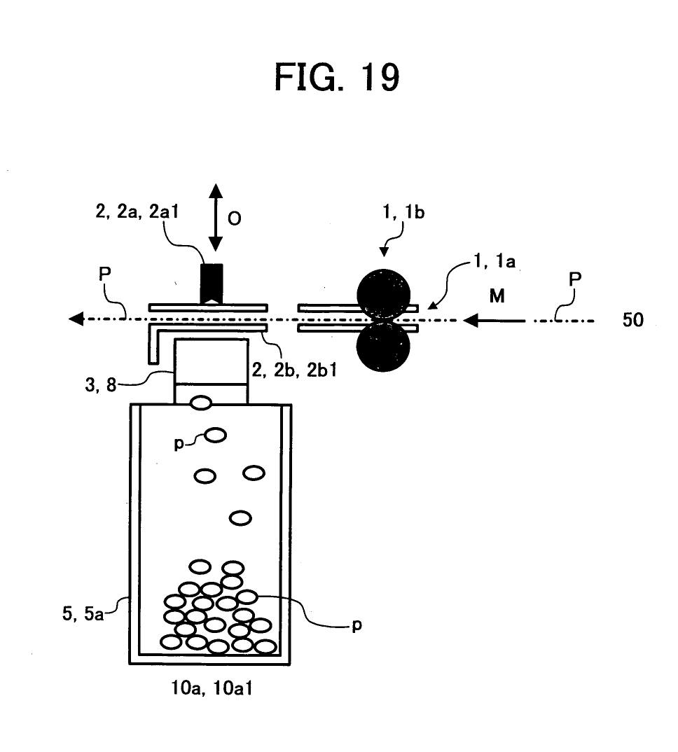

The perforating device 2 may either be of the press punch-type (see FIGS. 11 and 12), as shown in FIG. 19, or of the rotary punch-type (see FIGS. 13 and 14).

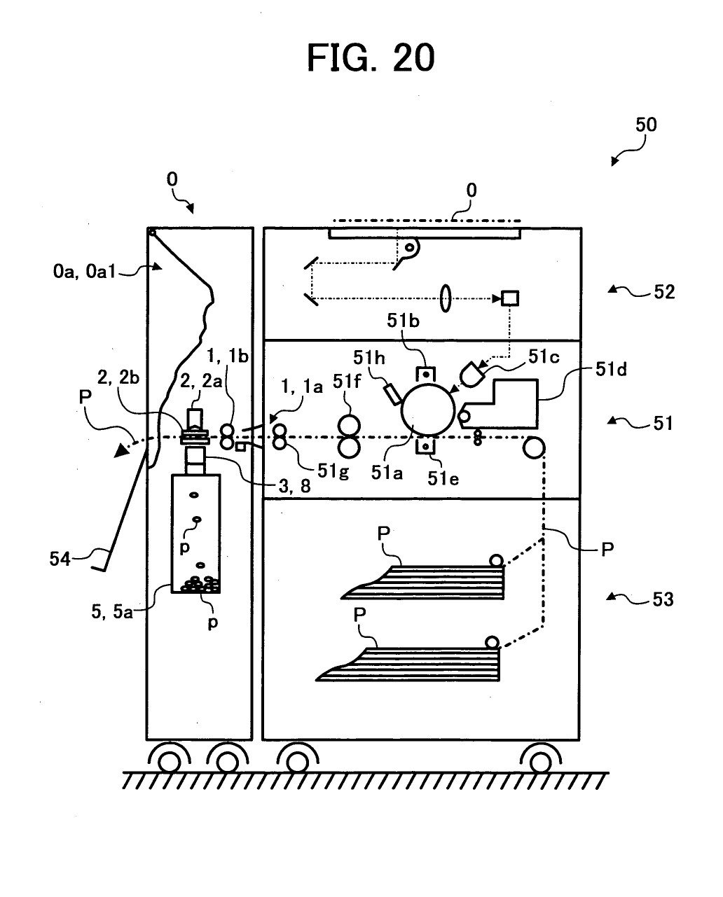

The configuration of an embodiment of an imaging apparatus equipped with the perforator of the present invention is shown in FIG. 20. In this diagram, the imaging apparatus 50 is composed of an imaging device 51 for forming an image on the paper P and a perforator 0 for perforating the paper P on which the image has been formed by the imaging device 51, the paper P fed to the perforator 0 is perforated by the press or rotary punch 2a and the die 2b, and the chad p resulting from this perforating operation is delivered to the operating side of the front cover 10a1 by the same configuration as in the embodiments previously described and is stored in the chad storage hopper 5a. Thus, it is possible to provide a compact imaging apparatus with a favorable appearance and superior operability, wherein erroneous detection and operation is prevented.

All types of apparatuses that use conventional imaging systems such as electronic photographing systems or ink-jet systems can be used for the imaging apparatus 50. Of these, a copy machine for forming a toner image in the same manner as with an electrophotographic system is configured such that a manuscript image reading device 52 for reading the image of a manuscript 0 is mounted in the top, and an imaging device 51 and a paper supply device 53 for supplying paper P to the imaging device 51 are mounted in the bottom. In the manuscript image reading device 52 of an imaging apparatus 50 based on this principle, a laser diode for an image writing device 51c is caused to generate light based on the image data of the manuscript 0 that has been read, the top of a photoreceptor drum of an image support 51a uniformly charged by an electrical charging device 51b is optically scanned, and an electrostatic latent image is formed on the surface of the photoreceptor drum. The image is then made visible by the toner development of the electrostatic latent image with a developing device 51d, and a toner image is formed.

The toner image made visible by the developing device 51d is transferred by a transferring device 51e to the paper P delivered from the paper supply device 53. The toner image transferred to the paper P by the transferring device 51e is fixed onto the paper P by the heat and pressure produced by a fixing device 51f, and the paper P on which the toner image is fixed is ejected to the feed opening 1a of the perforator 0 by a paper ejecting roller 51g.

Meanwhile, the photoreceptor drum of the image support 51a is cleaned by scraping off the adhered remaining toner with a cleaning member 51h after the toner image has been transferred to the paper P, and is used to form images in the next step. The paper P fed from the feed opening 1a of the perforator 0 is discharged and stored in an discharged paper tray 54 after being perforated by the operation of the punch 2a and die 2b.

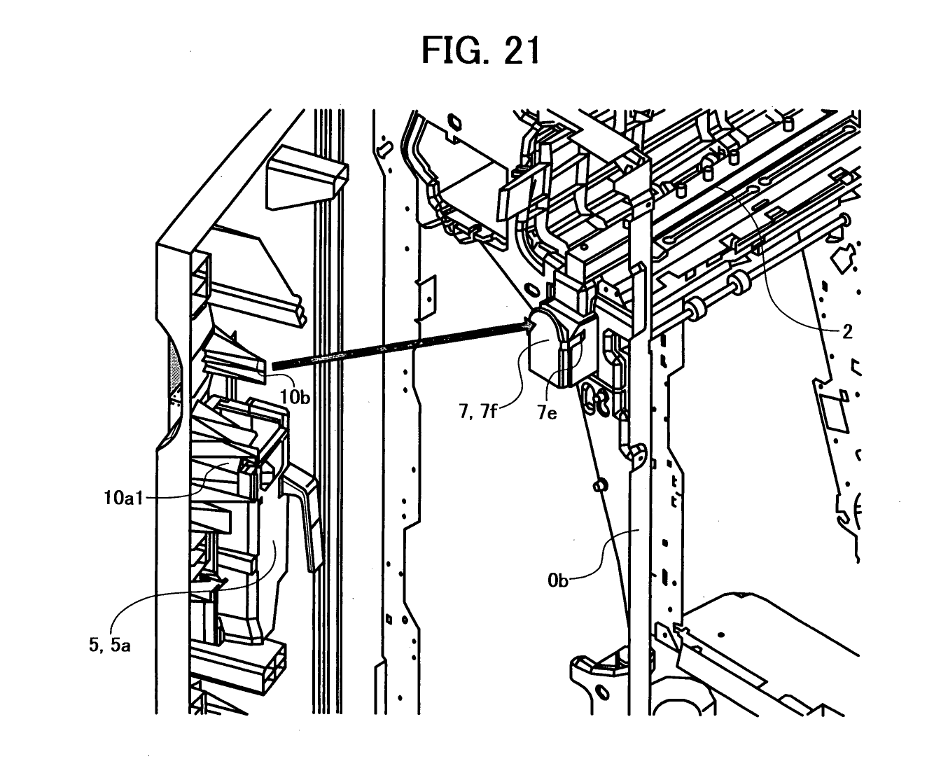

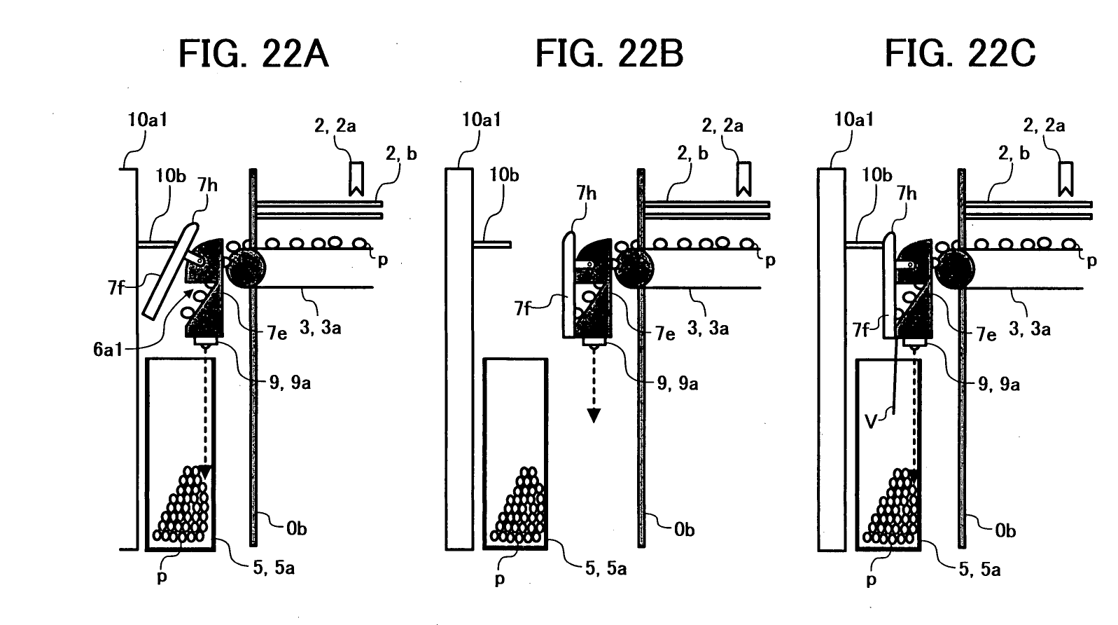

Following is a description of a paper finisher relating to another embodiment of the present invention shown in FIG. 21, and the operation of the perforator shown in FIGS. 22A through 22C.

This embodiment relates to the shielding member 7 shown in FIGS. 1 through 9, and another configuration whereby the shielding member 7 is operated. In this embodiment, the shielding member 7 is integrally formed from a shutter member 7f, an arm portion 7g that includes the fulcrum 7e at the tip, and an elastic urging device (spring) (not shown) for elastically urging the shutter member 7f in the normally closed direction. The arm portion 7g extends to the side of the main body of the chad guide 6 and can swing around the fulcrum 7e. When the shielding member 7 is not under a load (FIG. 22A), the shutter member 7f closes the opening 6a1 of the chad guide 6 by the elastic urging force of the elastic urging device, and the chad p is prevented from falling to the side of the chad storage hopper 5a. Also, the operating part 10b protruding into the front cover 10a1 comes into contact with a contact part 7h of the operating shutter member 7f at the top of the diagram, rotates the shutter 7f in the clockwise direction in the diagram against the elastic urging force of the elastic device, and allows the chad p to fall when the opening 6a1 is opened.

In this embodiment, the chad storage hopper 5a is detachably provided to the inner side of the front cover 10a1, and the amount of chad p stored in the chad storage hopper 5a is detected by a range sensor 9a provided as a detection device 9 to the bottom edge of the chad guide 6. This range sensor 9a detects the distance to the subject on the basis of the amount of light detected by a light-reflecting sensor and the light-receiving portion of the light-reflecting sensor, and functions as a fullness sensor for detecting whether the Chad storage hopper 5a has become full with Chad p. In this case, the distance is the height of the Chad p in the Chad storage hopper 5a.

Also, the detection device 9 functions as a range sensor 9a and can therefore double as a detecting sensor for the Chad storage hopper 5 because it is determined that the Chad storage hopper 5 is not mounted if the bottom of the Chad storage device 5 cannot be detected.

In this embodiment, closing the front cover 10a1 of the paper finisher 10 in the manner shown in FIG. 22A to enable finishing causes the operating part 10b to come into contact with the contact part 7h, turn the shutter member 7f in the clockwise direction, and open the opening 6a1 of the Chad guide 6. Opening the front cover 10a1 in the manner shown in FIG. 22B to disable finishing causes the operating part 10b to separate from the contact part 7h, and the shutter member 7f to close off the opening 6a1 (*5) by the elastic urging force of the elastic urging device. The Chad p scatters into the paper finisher 10 or enters the moving parts of other components if the shutter member 7f opens while the Chad storage hopper 5 has not reached a location where the scattering and falling Chad p can be adequately received, or if the shutter member 7f is closed off after the Chad storage hopper 5 has moved away from a position where the scattering and falling Chad p can be adequately received. The sensor may thereby give off an abnormality signal, or the paper finisher 10 may develop a malfunction.

In view of this, in the present embodiment, the shutter member 7f is set to be opened after the chad receiving inlet of the chad storage hopper 5 has reached a position where the chad p falling from the declining part 6a2 of the chad guide 6 can be adequately received, and the shutter member 7f is also set to be opened while the chad receiving inlet of the chad storage hopper 5 is disposed in a position where the chad p falling from the declining part 6a2 of the chad guide 6 can be adequately received. It is possible to set this type of timing by selecting the relative relationship between the amount by which the operating part 10b protrudes and the amount by which the chad storage hopper 5 protrudes from the front cover 10a1.

FIG. 22C shows the front cover 10a1 as it is being opened, from which it is apparent that the chad storage hopper 5 is still moving to a position capable of receiving the chad p when the shutter member 7f has been closed off. Similarly, when the front cover 10a1 is closed, the shutter member 7f is opened by being pushed further from the position in FIG. 22C, but at this time the chad storage hopper 5 has already reached the position where the chad p can be received.

In this embodiment, the fullness detection sensor and the presence/absence sensor for the chad storage hopper 5a are both combined in the range sensor 9a as described above, but when the chad p is detected to have filled up the chad storage hopper 5a by the range sensor 9a and when the front cover 10a1 is closed without the chad storage hopper 5a being mounted, a signal to this effect is sent toward the main body of the imaging apparatus 50. When the imaging apparatus 50 has received the signal, the imaging operation is stopped in a controlled manner until the aforementioned situation is resolved. Thus, the chad is prevented from scattering into the paper finisher 10, and erroneous operation in the device can be avoided.

In this embodiment, the operating part 10b is provided to the front cover 10a1 and the shutter member 7f is opened and closed according to the opening and closing of the front cover 10a1, but the operating part can also be provided integrally with the chad storage hopper 5a and similar operations can be performed via the operating part.

Also, in this embodiment, the chad storage hopper 5a is detachably mounted to the inner side of the front cover 10a1, but the main body frame 0b can also be provided with a supporting member and the chad storage hopper 5a can be detachably affixed thereto. In this case, the user attaches and removes the chad storage hopper 5a, and the opening and closing of the shutter member 7f can be coupled with the affixing and removing operation.

According to the embodiments described above, the chad can be prevented from falling or scattering into the apparatus because the opening of the chad guide is closed off.

Also, the chad can be prevented from falling or scattering into the apparatus because the chad can be reliably stored in the chad storage hopper.

Also, the chad can be prevented from falling or scattering into the apparatus because the chad can be prevented from overflowing in the chad storage hopper.

Also, the chad can be prevented from falling or scattering into the apparatus because scuffing is performed to prevent chad from forming when the chad storage hopper is not mounted.

Also, the chad can be prevented from falling or scattering into the apparatus because the chad slides off even when caught on the chad delivery channel shielding member and falls into the chad storage hopper.

Also, sensor or part malfunction can be prevented because the chad can be prevented from falling or scattering into the apparatus.

Furthermore, finishing and imaging can be performed efficiently because sensor or part malfunction can be prevented.

According to the present invention, chad can be reliably prevented from falling or scattering into the apparatus because the shielding member is disposed to be capable of moving back and forth between a chad transportation device and a chad storage device.

Various modifications will become possible for those skilled in the art after receiving the teachings of the present disclosure without departing from the scope thereof.

1. A perforator, comprising:
perforating means for perforating a sheet-shaped recording medium;
chad recovery/delivery means for delivering the chad perforated by the perforating means;
chad storage means for storing the chad delivered by the chad recovery/delivery means; and
shielding means for shielding discharge channels whereby chad is discharged from the chad recovery/delivery means to the chad storage means.

2. The perforator as claimed in claim 1, wherein the shielding means is openably/closably disposed on the discharge channels and prevents chad from falling to the side of the chad storage means.

3. The perforator as claimed in claim 1, wherein the shielding means begins a shielding release operation after all the discharge channels have opened for the inlet of the chad storage means for receiving the chad.

4. The perforator as claimed in claim 1, wherein the shielding means completes the shielding operation of the discharge channels while all the discharge channels are open for the inlet of the chad storage means for receiving the chad.

5. The perforator as claimed in claim 1, wherein the shielding means shields the discharge channels when an opening and closing door in the front surface of the perforator main body is open, and opens the discharge channels when the opening and closing door is closed.

6. The perforator as claimed in claim 5, wherein the chad storage means is provided to the opening and closing door on the perforator main body.

7. The perforator as claimed in claim 5, wherein the chad storage means is detachably provided to the inner side of the opening and closing door on the perforator main body.

8. The perforator as claimed in claim 7, further comprising detection means for detecting whether the chad storage means is mounted on the inner side of the opening and closing door.

9. The perforator as claimed in claim 8, wherein the detection means detects the amount of chad stored in the chad storage means.

10. The perforator as claimed in claim 1, wherein the shielding means comprises an opening and closing member that opens and closes an opening of the discharge channels for the chad storage means.

11. The perforator as claimed in claim 10, wherein the opening and closing member is swingably mounted in relation to a fulcrum provided in advance.

12. The perforator as claimed in claim 11, wherein the opening and closing member comprises a shielding part for shielding discharge channels and a through-hole for allowing chad to pass through.

13. The perforator as claimed in claim 12, wherein a slide surface for guiding the chad when the chad passes through is formed on the inner periphery of the through-hole.

14. The perforator as claimed in claim 11, further comprising elastic urging means for elastically urging the opening and closing member in the normally closed direction.

15. The perforator as claimed in claim 10, wherein the chad storage means is provided to an opening and closing door on the perforator main body.

16. The perforator as claimed in claim 10, wherein the chad storage means is detachably provided to the inner side of an opening and closing door of the perforator main body.

17. The perforator as claimed in claim 16, further comprising detection means for detecting whether the chad storage means is mounted on the inner side of the opening and closing door.

18. The perforator as claimed in claim 17, wherein the detection means detects the amount of chad stored in the chad storage means.

19. The perforator as claimed in claim 1, further comprising operating means for performing shielding and shielding release operations for the shielding means in conjunction with the opening/closing operation of the opening and closing door on the front surface of the perforator main body.

20. The perforator as claimed in claim 19, wherein the operating means is provided integrally with the opening and closing door.

21. The perforator as claimed in claim 19, wherein the operating means is provided integrally with the chad storage means.

22. The perforator as claimed in claim 19, wherein the chad storage means is provided to an opening and closing door on the perforator main body.

23. The perforator as claimed in claim 19, wherein the chad storage means is detachably provided to the inner side of an opening and closing door of the perforator main body.

24. The perforator as claimed in claim 23, further comprising detection means for detecting whether the chad storage means is mounted on the inner side of the opening and closing door.

25. The perforator as claimed in claim 24, wherein the detection means detects the amount of chad stored in the chad storage means.

26. The perforator as claimed in claim 1, further comprising:
guiding means for guiding the chad delivered by the chad recovery/delivery means to the chad storage means; and
separating means for separating the chad from the chad recovery/delivery means and transferring the chad to the guiding means.

27. The perforator as claimed in claim 26, wherein the separating means comprises chad separation accelerating means for accelerating the separation of the chad delivered by the chad recovery/delivery means.

28. A paper handler, comprising:
a perforator for perforating a sheet-shaped recording medium; and
processing means for performing a predetermined process on the recording medium, said perforator comprising:
perforating means for perforating the recording medium;
chad recovery/delivery means for delivering the chad perforated by the perforating means;
chad storage means for storing the chad delivered by the chad recovery/delivery means; and
shielding means for shielding discharge channels whereby chad is discharged from the chad recovery/delivery means to the chad storage means.

29. An imaging apparatus integrally or separately comprising:
imaging means for forming an image on a recording medium; and
a perforator for perforating the recording medium, wherein the perforator comprises:
perforating means for perforating the recording medium;
chad recovery/delivery means for delivering the chad perforated by the perforating means;
chad storage means for storing the chad delivered by the chad recovery/delivery means; and
shielding means for shielding discharge channels whereby chad is discharged from the chad recovery/delivery means to the chad storage means.

30. An imaging apparatus integrally or separately comprising:
imaging means for forming an image on a recording medium; and
a paper handler composed of a perforator for perforating the recording medium and processing means for performing a predetermined process on the recording medium, wherein the perforator comprises:
perforating means for perforating the recording medium;
chad recovery/delivery means for delivering the chad perforated by the perforating means;
chad storage means for storing the chad delivered by the chad recovery/delivery means; and
shielding means for shielding discharge channels whereby chad is discharged from the chad recovery/delivery means to the chad storage means.
